(19) United States
(12) Patent Application Publication
(10) Pub. No.: US 2020/0305450 A1
(43) Pub. Date: Oct. 1, 2020

(54) RAPID, PORTABLE FOOD SMOKING DEVICE

(71) Applicant: HALL OF FAME INNOVATIONS LLC, Canton, OH (US)

(72) Inventors: Brian Halasinski, Canton, OH (US); Kirk W. HYUST, Canton, OH (US); Karl H. Beitzel, Canton, OH (US)

(21) Appl. No.: 16/831,074

(22) Filed: Mar. 26, 2020

Related U.S. Application Data
(60) Provisional application No. 62/825,323, filed on Mar. 28, 2019.

(51) Int. Cl. A23B 4/052; A01J 25/16

(52) U.S. Cl. CPC A23B 4/0523; A23C 19/14; A01J 25/16

(57) ABSTRACT

A device for rapidly smoking food that is portable and adapted to accept and contain smoke from a smoke source. The smoking device has a housing with an internal chamber with a rack adapted to hold a food, such as one or more of a portion of solid food and a liquid such as a beverage. The device has a plurality of apertures that are sealable by a cover to contain smoke or other vapor within the device in order to infuse the food therewithin.

### CROSS-REFERENCE TO RELATED APPLICATIONS

This application claims priority under 35 USC § 119(e)(1) and § 120 to U.S. Provisional Patent Application Ser. No. 62/825,323 filed Mar. 28, 2019, herein fully incorporated by reference.

### FIELD OF THE INVENTION

The present invention relates to a device for rapidly smoking food that is portable and adapted to accept and contain smoke from a smoke source. The smoking device has a housing with an internal chamber with a rack adapted to hold a food, such as one or more of a portion of solid food and a liquid such as a beverage. The device has a plurality of apertures that are sealable by a cover to contain smoke or other vapor within the device in order to infuse the food therewithin.

### BACKGROUND OF THE INVENTION

Many different apparatuses are known to the art for smoking food. Designs of smokers are known that have a compartment in which smoke-producing material such as wood or charcoal is placed and burned. Smoke from the compartment travels to a part of the apparatus containing the food to be smoked. The smoker generally includes an inlet for airflow and an outlet to allow smoke and other gases to escape from the enclosure.

Smoke-producing materials include, but are not limited to, wood products such as woodchips, which can be soaked in water to aid in the creation of smoke, wood pellets, logs, and the like. Other smoke producing materials include liquids that provide a smoke flavor when heated. The smoke-producing material can be utilized as a source of heat production as well, or flammable gases such as propane or natural gas can be utilized in addition to the smoke-producing material.

Many food smokers are of relatively large size in order to house and smoke large pieces of meat, often multiple pieces of meat, and are often stand-alone units.

In addition to stand-alone units, some smoker apparatuses have been designed to be utilized in conjunction with a conventional gas or charcoal-fired grill. Such units are convenient for consumers who do not desire to purchase a stand-alone smoker. The apparatuses may have containers that can be placed over a heat source in a conventional gas or charcoal-fired grill so that smoke-producing material contained therein can be burned or otherwise heated to produce smoke, such as in the case of a liquid-based smoke product. An example of such a smoking apparatus is set forth in U.S. Pat. No. 10,021,889.

One problem with combination-type grill and smoker apparatuses is that the grilling surface must still be utilized and smoke from the smoking apparatus provided thereto in order to impart a smoke flavoring to the food product.

Still other smoking devices include hand-held smoke infusers, which, with combustible material such as woodchips, produce cold smoke. The infusers can be used for any kind of food or liquid. In addition to the infuser units, the person utilizing the device will need to have a further device to capture and contain the smoke produced thereby, such as a container or lid. Hand-held infusers also require batteries and smoke producing materials such as woodchips or pellets as well as an additional way to contain the smoke produced thereby.

In view of the above, the art still needs a portable food smoking device that is adaptable to funnel or capture and contain smoke from a smoke source that can be utilized to impart a smoke-like flavor to a food contained within the device.

### SUMMARY OF THE INVENTION

The problems noted above, and others are solved by the food smoking device of the present invention which includes an internal chamber with a rack adapted to hold one or more of a portion of solid food and a liquid beverage so that a smoke flavor can be provided thereto.

Advantageously, the food smoking device has a tubular housing with an internal chamber with a rack or other support member adapted to hold food to be infused with smoke, with the device including a plurality of apertures sealable by a cover to contain smoke within the device.

In a preferred aspect, the food smoking device is a cold smoker, designed to infuse smoke flavors into a food, such as a piece of meat or cheese or a liquid beverage such as a cocktail. The device is able to rapidly infuse a smoke flavor in a relatively short period of time, such as ten minutes or less.

In an additional aspect, the food smoking device has a structure that is relatively small in size and thus can be hand-held and portable from one location to another, providing wide applicability with respect to setting of use.

In a further aspect, the food smoking device has a configuration that allows a user to capture a vapor, smoke or the like, from an exhaust or outlet of a charcoal grill, smoker, or the like that has a vertically oriented port.

In yet a further aspect, the food smoking device is constructed such that a user can simply place the lower end thereof over a smoke producing material such as woodchips or pellets located on any surface which can accommodate the smoke-producing material, for example concrete, asphalt, tile, stone, stainless steel bowl, or any other non-flammable surface. Thus, it should be clear that with the food smoking device of the present invention, no actual separate grill or smoking unit is required.

In yet a further aspect, the food smoking device includes a plurality of covers, for example lids, that are utilized to capture smoke within the housing. Each cover is designed to close an aperture of the housing. In additional embodiments a cover can serve as a choke and selectively change the size of an aperture. In a preferred aspect, the device includes a top and bottom cover. This allows the user to access whatever is being smoked from the top of the device. In addition, the upper cover when closed captures the smoke from the smoke source. Once the device is full of smoke, the user can close the bottom cover to contain the smoke within the device.

In a further aspect, the food smoking device includes a housing having apertures located in a sidewall. This allows air to flow into the housing when the lower end of the housing is sealed by a cover or placed on a surface containing a smoke-producing material, wherein the surface does not allow airflow or substantial airflow into the housing. When a smoking process is complete or the unit is filled with smoke, the bottom cover can be closed, thereby sealing the apertures in the sidewall in order to keep the smoke contained within the smoking device.

In view of the above, it should be clear that the food smoking device of the present invention provides numerous advantages and benefits including, but not limited to, the ability to be utilized in conjunction with a charcoal or other grill that has a vertically-oriented exhaust; portability for on-the-go use; requires no electricity or battery, no glassware required for smoking, such as a lid; allows easy and quick smoking of food items such as cocktails, cheeses, sliced meats, fruits, vegetables, and ice-cream; the ability to perform with a very small amount of smoker pellets or woodchips in a smoker box or pellet tube; the ability to utilize various items used to infuse smoke such as cinnamon sticks, rosemary, or other herbs; and the ability to make restaurant-quality craft cocktails at home or outside of a restaurant setting with ease.

In one aspect, a portable device for smoking food is disclosed, comprising a housing having a tubular form, an upper end having an opening and a lower end having an opening, and a sidewall located between the upper end and the lower end, wherein the sidewall includes at least one aperture extending from an outer surface of the sidewall to an internal chamber of the housing that extends between the upper end and the lower end; an upper cover operatively connected to the housing and movable between a first position that seals the upper end opening and a second position where the opening is not sealed; a lower cover operatively connected to the housing and movable between a first position that seals the lower end opening and a second position where the opening and the at least one sidewall aperture are sealed; a handle for holding the device connected to the housing; and a rack located in the internal chamber that is temporarily or permanently connected to the housing.

In a further embodiment the lower cover includes a cover base and cover sidewall extending from the cover base, and wherein the cover sidewall seals the at least one sidewall aperture when the lower cover is in the first position.

In yet another embodiment the one sidewall aperture comprises a plurality of apertures spaced around the lower end opening on the sidewall.

In still a further embodiment the upper cover and the lower cover are hingedly connected to the housing.

In a further embodiment the rack includes a base mounted to the sidewall via projections on the base which extend through rack apertures in the sidewall of the housing.

In yet another embodiment the rack includes a wire holder adapted to hold a portion of food.

In still a further embodiment the holder is cylindrical and is adapted to hold a cup or glass, and wherein the holder extends upwardly from the base.

In a further embodiment the upper cover includes a cover base and a cover sidewall extending from the cover base, and wherein the handle includes an extension including a portion of a hinge, and wherein the upper cover is hingedly connected to the handle extension.

In a further embodiment the handle includes a second extension including a portion of a hinge and the lower cover is hingedly connected to the second handle extension.

In yet another embodiment the housing is substantially cylindrical.

In a further embodiment the handle is connected to the sidewall.

In still a further embodiment the upper cover includes a cover base and a cover sidewall extending from the cover base, and wherein the handle includes an extension including a portion of a hinge, and wherein the upper cover is hingedly connected to the handle extension.

### BRIEF DESCRIPTION OF THE DRAWINGS

The invention will be better understood, and other features and advantages will become apparent by reading the detailed description of the invention, taken together with the drawings, wherein:

FIG. 1 is a left-rear perspective of one embodiment of a food smoking device of the present invention including an upper cover and a lower cover in a closed position;

FIG. 2 is a side view of the embodiment shown in FIG. 1;

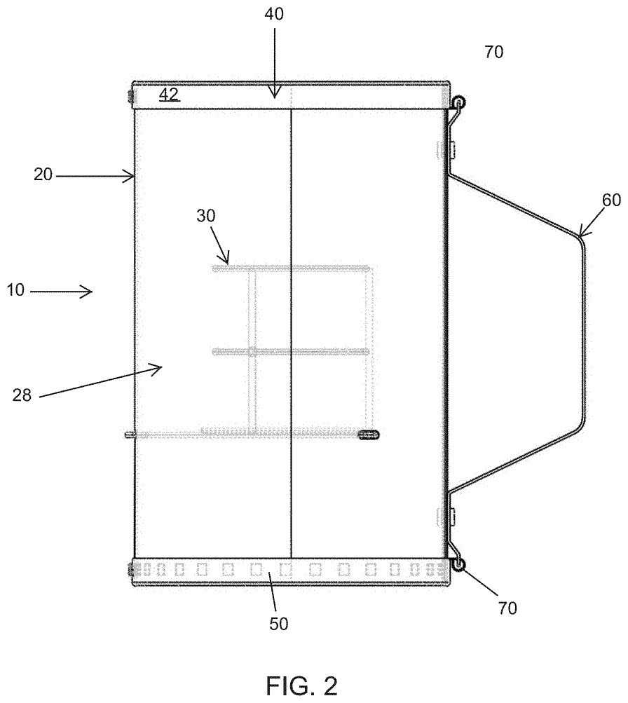

FIG. 3 is a left-rear perspective view of an embodiment of the smoking device showing the upper cover in an open position, with the upper cover connected to a portion of the handle with a hinge;

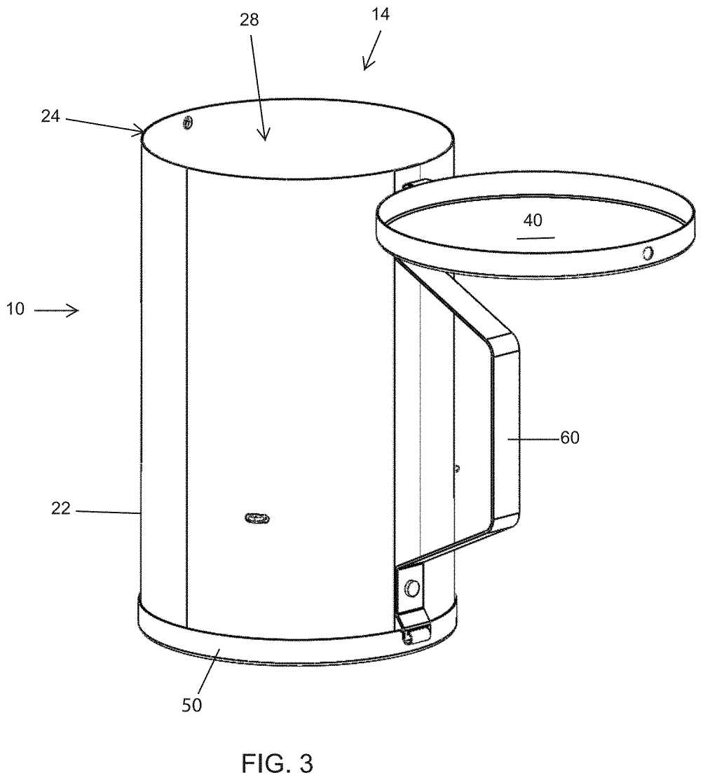

FIG. 4 is a front left perspective view of an embodiment of the smoking device showing the upper cover and lower cover in an open position, thereby exposing sidewall apertures at a lower end of the housing;

FIG. 5 is a left-rear perspective view of the embodiment illustrated in FIG. 4. The rack can be seen connected to a sidewall of the housing;

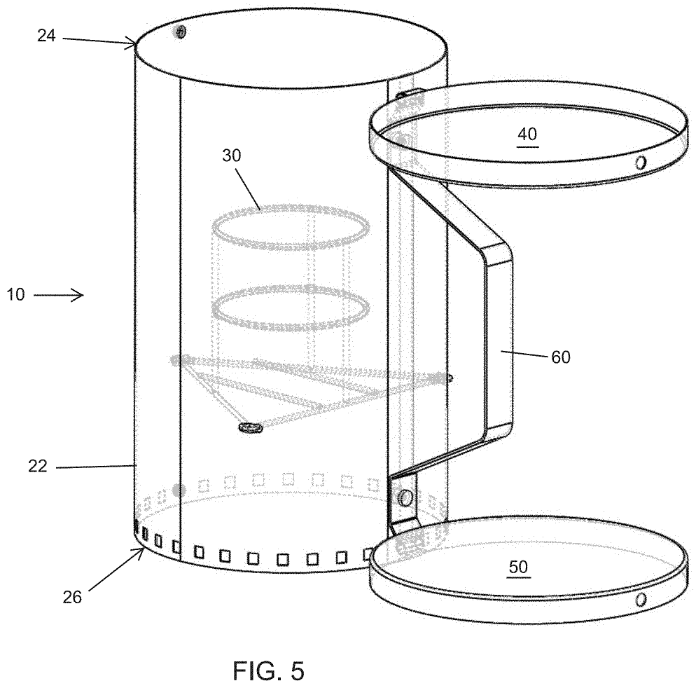

FIG. 6 is a top view of an embodiment of the smoking device showing the upper cover in an open position, thereby exposing the rack which includes a base and holder for a food item; and

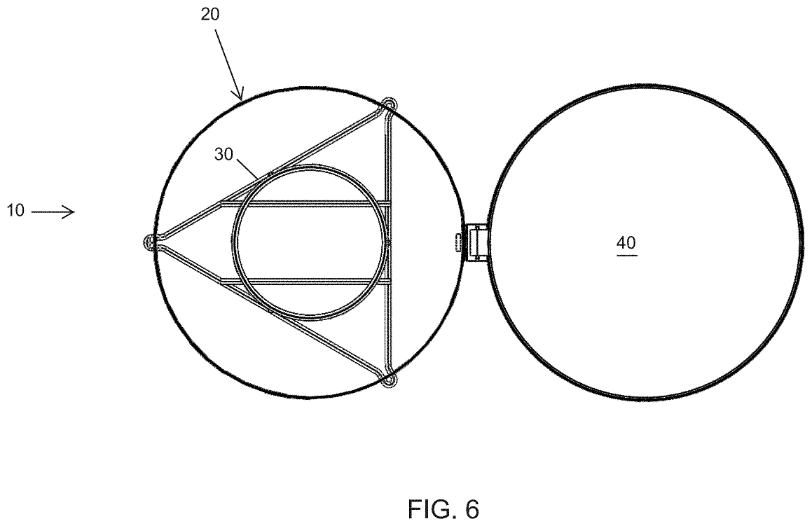

FIG. 7 is a side view of the embodiment illustrated in FIG. 5.

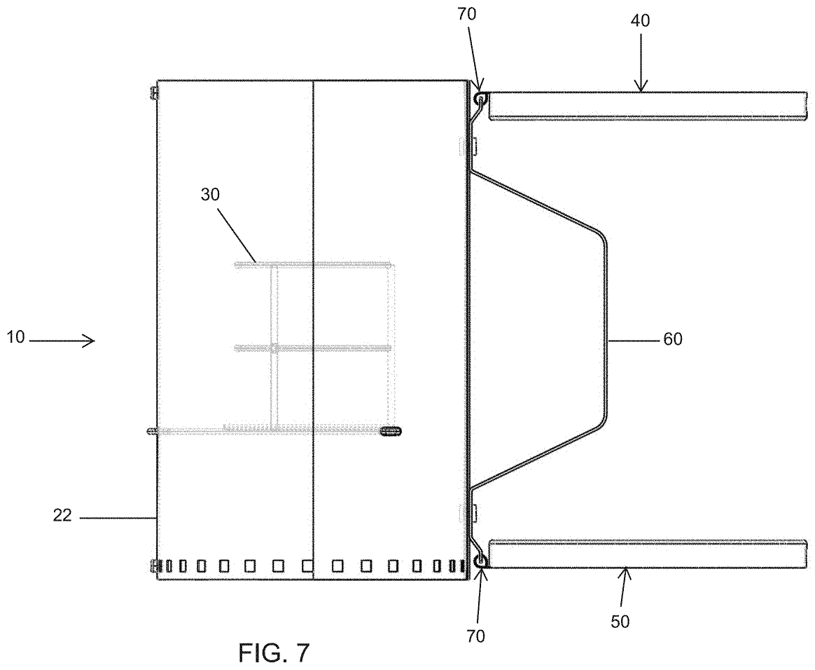

### DETAILED DESCRIPTION OF THE INVENTION

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

A food smoking device 10 is shown in the figures. Device 10 generally includes a housing 20, illustrated in tubular form, an upper cover 40, a lower cover 50, a handle 60, and a rack 30 located in internal chamber 28 of housing 20. These elements provide a portable food smoking device that is adapted to be utilized in a wide variety of environments.

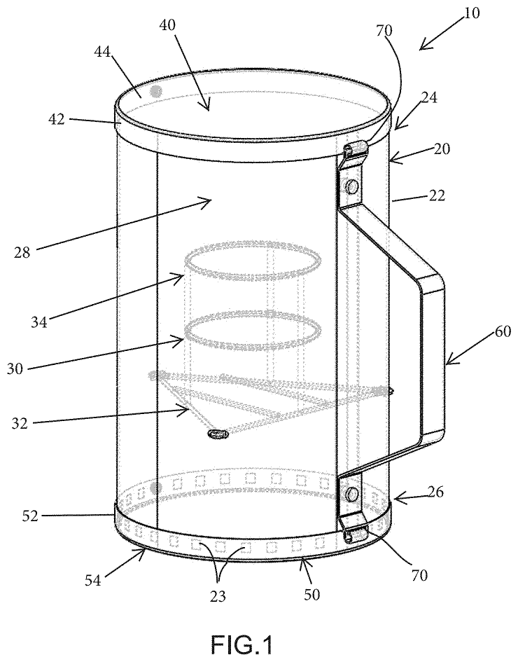

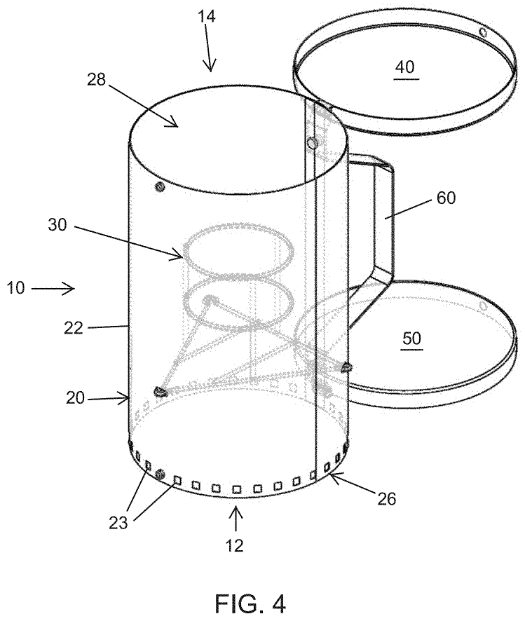

Housing 20 is a tubular member having an upper end 24 with a smoke outlet 14, and having a lower end 26, having a smoke inlet 12, as particularly illustrated in FIG. 4. Housing 20 can be any tubular-shaped member having openings preferably at both upper end 24 and lower end 26. While the tubular form shown in FIG. 1 is cylindrical, it is to be understood that other tubular forms can be utilized, for example, but not limited to, square, rectangular, oval, triangular, hexagonal, octagonal, or the like.

During use, the lower end 26 of housing 20 or lower cover 50 can be placed upon a suitable surface. When the smoking device 10 is being utilized to collect smoke, the lower cover 50 will be removed from lower end 26 so that smoke can enter therethrough and/or through sidewall apertures 23 in sidewall 22, see FIG. 4.

A round, generally cylindrical shape is preferred in one embodiment due to ease of manufacturing and use. Housing 20 can be constructed of any flame-resistant, durable material, such as corrosion resistant steel, stainless steel, aluminium, or high-temperature resistant plastic.

As shown in the drawings, the housing 20 forms an internal chamber 28 extending between upper end 24 and lower end 26 that serves as a channel for flow of smoke and/or vapor, such as from a smoke producing material or other device such as a grill or smoker.

In one preferred aspect, sidewall 22 is provided with at least one and preferably a plurality of spaced sidewall apertures 23 that allow air into the internal chamber 28 when lower cover 50 is in an open position. These apertures 23 can be closed by lower cover 50, such as shown in FIG. 1 such that cover sidewall 52 prevents airflow therethrough. Apertures 23 are particularly useful in an application where lower end 26 is covered or closed via a surface or object during use. The size of each sidewall aperture 23 can vary depending upon desired airflow into device 10.

As shown in the figures, a rack 30 is located in internal chamber 28 of housing 20 and operatively connected thereto. The rack 30 can be permanently or temporarily connected to housing 20 as desired. When the rack 30 is temporarily connected, it can be removed for cleaning or replacement with a rack of a different configuration. Rack 30 as illustrated includes a base 32 which is mounted to sidewall 22 via projections on the base which extend through sidewall 22 of housing 20. Rack 30 also includes a holder 34 adapted to hold a portion of food, such as a food item or a drink adapted to be infused with smoke or vapors.

The configuration of the holder 34 of rack 30 in FIG. 1 is adapted for use with a cup or glass that can be set therein in order to infuse the food, solid and/or liquid, contained therein with smoke. Rack 30 is preferably formed from a durable material such as a metal in some embodiments. Wire-like construction is shown in the drawings. In addition, the rack can be designed having an outer segment around the central cylindrical holder to accommodate additional food items. Also, a wire grate, such as a 6-inch grate can be utilized to hold any number of food items such as meat and cheese that can be cold smoked. In addition, a multi-tier rack can be utilized that can be lowered through the top of the device. The multi-level rack is able to accommodate large quantities of food items to be smoked. A grate-type or porous construction is employed for rack 30 so that airflow through housing 20 is not substantially impeded and a desired smoke flavor is imparted to a food held by rack 30.

A handle 60 is mounted on an exterior surface of housing 20 in order to protect a user's hand from heat radiating from housing 20 and allow manipulation of the smoking device 10.

Handle 60 can be mounted to the housing 20 utilizing any desired means, such as rivets, screws, or bolts and nuts.

One or more of upper cover 40 and lower cover 50 can be mounted to smoking device 10 via an extension of handle 60 utilizing a hinge 70. Hingedly mounting or otherwise operatively fixing upper cover 40 and lower cover 50 to housing 20 insures that the cover will not be displaced from food smoking device 10 and potentially lost. In addition, the covers 40 and 50 are easily moved from a closed position to an open position and can be manipulated by hand to provide the device 10 with a desired configuration.

As mentioned herein, upper cover 40 includes a cover sidewall 42 and a cover base 44. Similarly, lower cover 50 includes a cover base 54 and cover sidewall 52, that seal sidewall apertures 23 when lower cover 50 is in a closed position.

For the avoidance of doubt, it is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

In accordance with the patent statutes, the best mode and preferred embodiment have been set forth; the scope of the invention is not limited thereto, but rather by the scope of the attached claims.

What is claimed is:

1. A portable device for smoking food, comprising:
a housing having a tubular form, an upper end having an opening and a lower end having an opening, and a sidewall located between the upper end and the lower end, wherein the sidewall includes at least one aperture extending from an outer surface of the sidewall to an internal chamber of the housing that extends between the upper end and the lower end;
an upper cover operatively connected to the housing and movable between a first position that seals the upper end opening and a second position where the opening is not sealed;
a lower cover operatively connected to the housing and movable between a first position that seals the lower end opening and a second position where the opening and the at least one sidewall aperture are not sealed;
a handle for holding the device connected to the housing; and
a rack located in the internal chamber that is temporarily or permanently connected to the housing.

2. The device according to claim 1, wherein the lower cover includes a cover base and cover sidewall extending from the cover base, and wherein the cover sidewall seals the at least one sidewall aperture when the lower cover is in the first position.

3. The device according to claim 2, wherein the at least one sidewall aperture comprises a plurality of apertures spaced around the lower end opening on the sidewall.

4. The device according to claim 3, wherein the upper cover and the lower cover are hingedly connected to the housing.

5. The device according to claim 1, wherein the rack includes a base mounted to the sidewall via projections on the base which extend through rack apertures in the sidewall of the housing.

6. The device according to claim 5, wherein the rack includes a wire holder adapted to hold a portion of food.

7. The device according to claim 6, wherein the holder is cylindrical and is adapted to hold a cup or glass, and wherein the holder extends upwardly from the base.

8. The device according to claim 2, wherein the upper cover includes a cover base and a cover sidewall extending from the cover base, and wherein the handle includes an extension including a portion of a hinge, and wherein the upper cover is hingedly connected to the handle extension.

9. The device according to claim 8, wherein the handle includes a second extension including a portion of a hinge and the lower cover is hingedly connected to the second handle extension.

10. The device according to claim 1, wherein the housing is substantially cylindrical.

11. The device according to claim 1, wherein the handle is connected to the sidewall.

12. The device according to claim 11, wherein the upper cover includes a cover base and a cover sidewall extending from the cover base, and wherein the handle includes an extension including a portion of a hinge, and wherein the upper cover is hingedly connected to the handle extension.

13. The device according to claim 12, wherein the handle includes a second extension including a portion of a hinge and the lower cover is hingedly connected to the second handle extension.

14. The device according to claim 1, wherein the upper cover and the lower cover are connected to the housing such that they can rotate at least 180°.

15. The device according to claim 1, wherein the at least one sidewall aperture comprises a plurality of apertures spaced around the lower end opening on the sidewall.

16. The device according to claim 15, wherein the lower cover includes a cover base and cover sidewall extending from the cover base and wherein the cover sidewall seals the plurality of apertures when the lower cover is in the first position.
